(19) United States
(12) Patent Application Publication
(10) Pub. No.: US 2014/0006096 A1
(43) Pub. Date: Jan. 2, 2014

(54) SYSTEM AND METHOD FOR DETERMINING CONGESTION USING POINT OF SALE AUTHORIZATION DATA

(71) Applicant: Peter GROARKE, Dublin (IE)

(72) Inventor: Peter GROARKE, Dublin (IE)

(73) Assignee: MASTERCARD INTERNATIONAL INCORPORATED, Purchase, NY (US)

(21) Appl. No.: 13/538,270

(22) Filed: Jun. 29, 2012

(51) Int. Cl. G06Q 30/02

(52) U.S. Cl. 705/7.29

(57) ABSTRACT

A system and a method for determining at least one of vehicle and pedestrian congestion at locations, comprising an electronic storage device having a database of merchant transactions stored therein; an access path for allowing access to information concerning the transactions, including when point of sale transactions have taken place, and a processor for assembling the information concerning point of sale transactions, to provide an indication of at least one of vehicle and pedestrian congestion. A computer readable non-transitory storage medium stores instructions of a computer program which when executed by a computer system, results in performance of steps of the method for determining at least one of vehicle and pedestrian congestion.

### BACKGROUND OF THE DISCLOSURE

1. Field of the Disclosure

The present disclosure relates to payment card systems. More particularly, it relates to methods for exploiting the information generated by the transactions conducted on such systems.

2. Description of the Related Art

The first credit payment systems were two party systems in which a merchant sold goods to a customer without requiring full or any initial payment, but where the customer paid for the goods at a later date, or may have made periodic payments over a predetermined period of time. This method of payment is of limited scope and is not flexible, in that it involves only one merchant, and the customer must make individual arrangements with each and every merchant, and for each and every transaction.

In a three party system, a single card issuer contracts with customers and issues credit cards to them. The issuer also contracts with merchants, who agree to make sales to customers having a credit card from the issuer. When a card is presented at a merchant's establishment, it is generally the issuer who approves the transaction and pays the merchant. However, this system, a so-called closed system, has occasionally been modified so that another party approves the transaction and interacts with the merchant.

MasterCard, the assignee of the present application, operates within what is known as a “four-party” open payment card system. The four key participants in a four-party system are: (i) the consumer and business cardholders that use the cards; (ii) the merchants that accept the cards; (iii) the financial institutions that issue the cards (referred to as the card issuer); and (iv) the financial institutions that sign up merchants to accept the cards (referred to as the acquirer). In a typical four-party payment card transaction, the merchant pays a “merchant discount fee” (i.e., a merchant service charge) to the acquirer in recognition of the services provided by the acquirer in facilitating payment card acceptance by the merchant. However, a substantial portion of the benefits that the merchant receives through card acceptance comes from the value of the network and services performed by the card issuer. For example, the card issuer underwrites and extends credit to the cardholder of a credit card, which enables the sale, and the card issuer assumes the risk of nonpayment by the cardholder, which enables the merchant to get paid for the transaction even if card issuer does not. To compensate the card issuer for providing such benefits to the acquirer's merchant customer, the acquirer pays an “interchange fee” to the card issuer in connection with a payment card transaction. The interchange fee helps to partially reimburse the card issuer for the many activities it performs and costs it incurs that enable the acquirer to provide significant benefits and value to its merchant customers. Interchange fees are only one of the many cost components of the merchant discount fees that are established by acquirers and paid by merchants in exchange for card acceptance services provided by acquirers to merchants.

In general, the transaction system and associated methods described above work. However there are situations in which additional convenience for the user would be desirable.

### SUMMARY OF THE DISCLOSURE

An embodiment of the invention is directed to a method (and a system) for determining at least one of vehicle and pedestrian congestion at locations, comprising an electronic storage device having a database of merchant transactions stored therein; an access path for allowing access to information concerning the transactions, including when point of sale transactions have taken place, and a processor for assembling the information concerning point of sale transactions, to provide an indication of at least one of vehicle and pedestrian congestion. The database has data concerning transactions in a given geographic region. More specifically, the database can have data relating to payment card transactions, and the data is preferably filtered to remove card holder information related to the transactions.

The access path can comprise a web site for making the data available to users of the web site. The access path can include an Internet connected device for connecting to the web site. The Internet connected device can be selected from the group consisting of a mobile telephone, including a desktop, laptop or notebook computer, a tablet, a personal digital assistant and the like, or any device providing similar functions.

The Internet connected device can include a display screen for displaying information concerning merchant establishments at a place where congestion is present. The merchant establishments can be displayed as markers on a map.

The present disclosure provides, in an exemplary embodiment, that when data in the database indicates that there is no longer congestion at a location, a marker corresponding to the merchant establishment can be changed.

The disclosure is also directed to a computer readable non-transitory storage medium for storing instructions of a computer program which when executed by a computer system results in performance of steps of the method described for providing an indication of at least one of vehicle and pedestrian congestion.

### BRIEF DESCRIPTION OF THE DRAWINGS

FIG. 1 is a diagram of a four party payment card system.

FIG. 2 is a block diagram of a portion of a payment card system modified in accordance with one aspect of the present disclosure.

FIG. 3 is a flow chart representing the manner in which acquired data is filtered to preserve confidentiality.

FIG. 4 is a flow chart illustrating the manner in which the system in accordance with the present disclosure is used.

A component or a feature that is common to more than one drawing is indicated with the same reference number in each of the drawings.

### DESCRIPTION OF THE EMBODIMENT

A payment card network having real-time point of sale data for a given location can be used to determine the congestion of vehicles or pedestrians at a given location, or in its vicinity.

If the transaction data from point of sale (POS) is taken into consideration (that is situations in which the payment card is present at the transaction) and is aggregated from several merchants, and combined with the precise merchant locations, it can be used to build a software map of where vehicles and pedestrians are located. Such a “congestion map” is of use to numerous user groups, and has numerous applications. For example, data representative of point of sale transactions for certain “merchant types” or “transaction types” have particular utility, such as bridge and road toll “sales” data. A software generated map of this data, indicating vehicular congestion when there is a high volume of point of sale transactions in a given time period, is particularly useful to various groups, including but not limited to, professional delivery services and personnel, taxi and limousine services, emergency services, commuters, and those individuals who may be mobility impaired.

In cases of a natural disaster, such as a hurricane, such software maps may be useful to emergency response services in determining regions of disruption, where point of sale activity has been reduced from what is considered to be normal activity levels. Such determinations may be made on a relatively fine scale, and in some cases on a street-by-street basis.

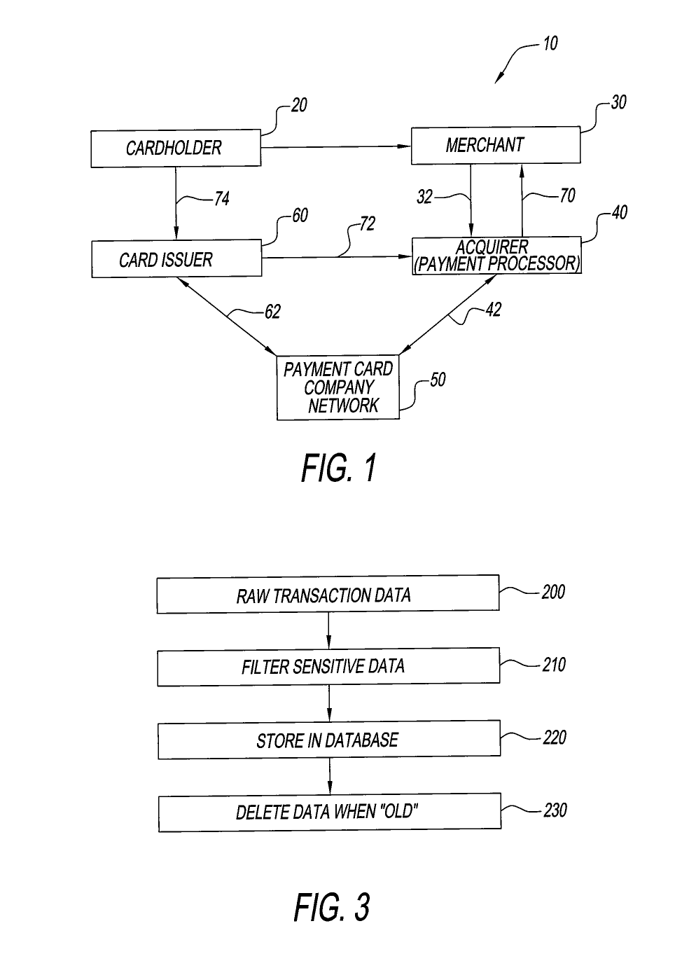

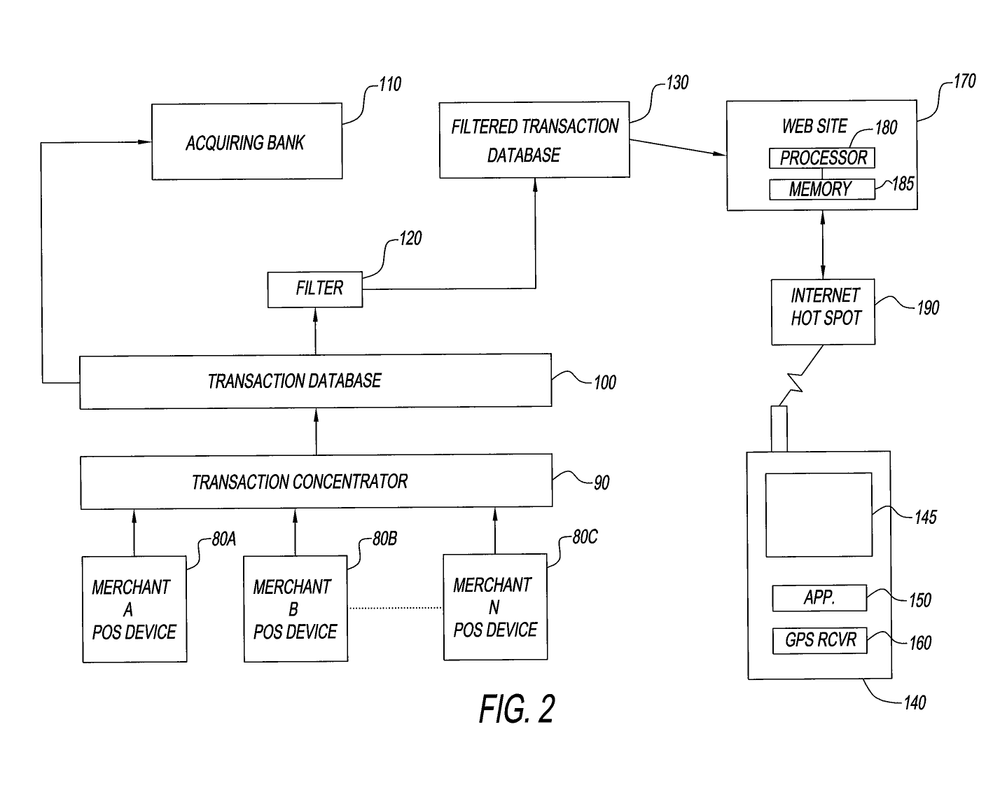

Referring to the drawings and, in particular, FIG. 1, there is shown a four party system 10. The card holder 20 submits the payment card to the merchant 30. The merchant's point of sale device (80 in FIG. 2) communicates 32 with his acquiring bank or acquirer 40, which acts as a payment processor. The acquirer 40, at 42, initiates the transaction on the payment card network 50. The payment card network 50 routes the transaction to the issuing bank or card issuer 60, which is identified using information in the transaction message, more fully described below. The card issuer 60 approves or denies an authorization request. At 62, the card issuer 60, then routes, via the payment card network 50 an authorization response back to the acquirer 40. The acquirer 40 sends approval to the POS device of the merchant 30. Seconds later, the cardholder completes the purchase and receives a receipt.

The account of the merchant 40 is credited at 70 by the acquirer 40. The card issuer 60 pays the acquirer at 72. Eventually, at 74, the cardholder 20 pays the card issuer 60.

Referring to FIG. 2, each merchant has on their premises at least one card swiping machine or point of sale device 80, of a type well known in the art, for initiating customer transactions. These point of sale devices 80A, 80B, . . . 80N, generally also have keyboard data entry pads for entering data when a card's magnetic coding becomes difficult to read, or for the purpose of entering card data resulting from telephone calls during which the customer provides card data by telephone. Point of sale devices 80A, 80B, . . . 80N are connected by a suitable network to a transaction concentrator 90, for a given geographic area, which concentrates the transaction information. Each concentrator 90 has associated with it a transaction database 100 that stores information concerning the transaction. Information from the concentrator 90 is routed to a respective acquiring bank 110 that, in turn, routes the information so that transactions are properly completed using the system illustrated in FIG. 1.

While it is advantageous to maintain a local database including transactions in a given geographic area, there is no such limitation on various embodiments of the present disclosure. For example, if the present disclosure is used with a three party system, data for a relatively large geographic region may be stored in a single database at a central location. The time to search this more extensive database, and provide a response to a user, may be slightly greater, but the user will obtain the same useful information.

Information that is exchanged across the network for each credit or debit card financial transaction message includes the following characteristics: acquirer identifier/card accepter identifier (the combination of which uniquely defines the merchant); merchant address (i.e., full address and or GPS data); merchant category code (also known as card acceptor business code), that is an indication of the type of business the merchant is involved in (for example, a gas station); local transaction date and time, cardholder base currency (i.e., U.S. Dollars, Euro, Yen, etc.), the transaction environment or method being used to conduct the transaction (as more fully explained below), product specific data such as SKU line item data, and cost of the transaction.

While merchant address information in the transaction may be incomplete, it can be combined with a database of merchant identifications and precise merchant location information, such as the full address and/or GPS coordinates data for the location of the merchant. The information can be graphically displayed, as more fully described below.

Transaction records stored in transaction database 100 contain information which is highly confidential and must be maintained as such to prevent fraud and identity theft. The transaction records stored in transaction database 100 are sent through a filter 120 (FIG. 3) which removes confidential information, but retains records concerning merchant identification and the occurrence of transactions at various times; preferably in real time. The filtered data is stored in a filtered transaction database 130 which may be accessed as described below. The data of the database may be stored in any type of memory, including a hard drive, a flash memory, on a CD, in a RAM, or any other suitable memory.

The following example of an approach to accessing the data involves a mobile telephone. However, it will be understood that that there are various other approaches, technologies and pathways that can be used. These include various types of alerts such as telephone calls, text messages, instant messages and e-mails. However, for speed of response, a so called “push” technology should be used, where information is “pushed” out to the user, rather than waiting until the user decides to again check for messages. Any of these technologies can be used to provide locations, or in some cases a map of locations, where congestion is present.

A mobile telephone 140, having a display 145, may have a series of applications or applets thereon including an applet or application program (hereinafter an application) 150 for use with the embodiments described herein. Mobile telephone 140 may also be equipped with a GPS receiver 160 so that its position is always known. Alternatively, if no GPS receiver is provided, application 150 may have provisions for entering the current location of the mobile telephone 140, such as for example the name of the town, and the streets forming an intersection where the mobile telephone 140 is located.

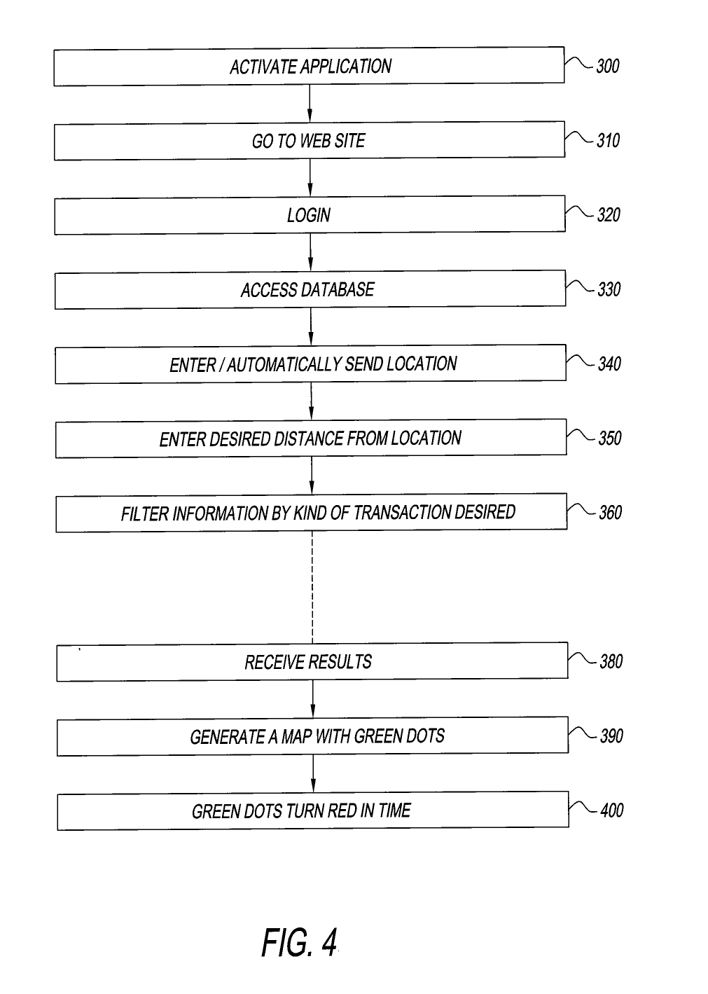

Mobile telephone 140 may be used to access a website 170 on the Internet, via an Internet connected Wi-Fi hot spot 190 (or by any telephone network, such as a 3G or 4G system, on which mobile telephone 140 communicates), by using application 150. Website 170 is linked to database 130 so that authorized users of website 170 may have access to the data contained therein. The manner in which that access is exploited, in accordance with the present disclosure, is described with respect to FIG. 4.

Web site 170 has a processor 180 for assembling data from filtered transaction database 130 for responding to user inquiries, as more fully discussed below with respect to FIG. 4. A memory 185 associated with web site 170, having a non-transitory computer readable medium, stores computer readable instructions for use by processor 180 in implementing the operation of the disclosed embodiment.

While the system and method described herein are preferably used with a mobile device, because, in general, it may advantageously serve individuals who are away from a home or business location, and would like to receive “pushed” messages, it will be understood that web site 170 may be accessed from a home or business computer, from a personal digital assistant, or any other Internet connected device, such as a tablet (for example, a device such as an iPad®). As an example, if an individual has been working late on a Friday night, but does not want to go home, the system and method described herein may be accessed from an office computer to determine where and the extent of pedestrian congestion, to indicate where the “hot spots” for socializing with other individuals may be found. An individual wishing to show off a new article of clothing, such as “hot pants” to as large an audience as possible, will need to find a location with high pedestrian traffic, as evidenced by the large number of point of sale transaction occurring in the general area. In addition, places of high vehicular traffic may be found so that they are avoided, to the extent possible, when traveling to such “hot spots”. On the other hand, if a person is very hungry, and wishes to eat at a restaurant in just a few minutes, a location showing low pedestrian traffic may be preferred, as it will generally indicate that the restaurant is not very busy.

Referring to FIG. 3, the operation of filter 120 (FIG. 2) is illustrated. The raw transaction data usually exchanged over the network is acquired at 200. At 210, customer sensitive information such as the credit card number and expiration date and other customer sensitive information is removed. At 220, the remaining data is stored in database 130 (FIG. 2). At 230, after a relatively short time, data which is no longer current or has become “old” in the context of the present embodiment, can be removed from the database. This serves to conserve space in the memory associated with database 130 and is permissible because, in general, transaction data which is more than, for example, in some cases, several minutes or several hours old will not be helpful in indicating whether there is congestion at a particular location.

FIG. 4 illustrates the manner in which the present method or system is used by a customer. At 300, the user activates application 150 on mobile telephone 140 (FIG. 2). Assuming that Internet access is available, at 310, optionally, the user will be directed to a log-in page of website 170 (FIG. 2). At 320, the user logs in with a user identification and password in a conventional manner, well known in the art. At 330, access is granted to the information in database 130

The manner in which the owner of web site 170 exploits the present method and system can vary. The web site may be available free to the public. Alternatively, a user fee may be charged, on a time of use, or periodic basis (such as monthly). Web site 170 may be made available only to card-holders of the type of card being used to make those transactions, or only for free to such card holders. There are other possibilities for providing access to the web site.

At 340, information which is relevant to the location specified by the coordinates obtained from the GPS receiver 160 in mobile telephone 140, the entered location information, a predefined default location, or some other method of determining location, whether now know or later developed, can be sent from the mobile telephone 140 to the web site 170.

At 350, using mobile telephone 140, the user enters a desired distance or radius from the GPS determined or entered location, for the existence of locations where there is congestion, as evidence by point of sale transactions.

At 360, if desired, it is possible to make an entry via mobile telephone 140 that filters the high congestion information to display only information relating to a type of transaction. For example, it may be that only a bar or restaurant is of interest to a user at a particular time. It may also be that a user wishes to avoid an area which is highly congested due to a rock and roll concert being performed by a very popular performer or group. In this case, point of sale information from concession stands, ticket sales and souvenir sales may be utilized to indicate a congested location. Information indicating point of sale payments for parking may indicate the arrival of many automobiles at, for example, a sports arena, or the departure of many vehicles from a shopping mall parking lot, or a city parking lot, at the end of the work day.

At 380, the user will receive the results of a search in database 130 specific to the selected geographic area. As noted above, this information may be “pushed” out to the potential customer, and may not arrive for some time. The lack of a connection between 360 and 380 is representative of this potential time delay. However, in some cases, the data may be available almost immediately. The data may be in the form of a list of locations having a large number of point of sale transactions, or such transactions of a specified type, and addresses and telephone numbers of local merchants, shown on display 145 of mobile telephone 140. Alternatively, a map may be generated with, for example, at 390, green dots indicating the location of areas having a large number of point of sale transactions. Application 150 may be configured so that if one of these locations on a map is selected by, for example, using a cursor, the exact names and addresses for local business establishments is provided. After some time, if the data no longer indicates congestion, the dots may change is color, as at 400, or be removed from the map, as an indication or a warning that congestion is no longer present.

Thus, it is clear that the embodiments described herein benefit customers, as they are proactively given timely information on the congestion in a specific geographic area. The system benefits retailers because potential customers are proactively informed of the availability of less congested regions, thus increasing sales for those customers seeking to avoid congested areas, or who may desired very prompt service. Delivery personnel can reschedule their routes to avoid congestion so that deliveries are made more efficiently. Emergency service personnel can determine that there may be a problem in an area showing less point of sale transactions, or may utilize the data to find routes that are not congested to rapidly reach persons in need of urgent assistance, in regions where they know there is serious trouble. Customers seeking areas of congestion which may promote social interaction, especially with people who they have not met before, can locate such congested areas. Retailer also avoid the difficulties, including at least the time and expense, associated with having to provide updates to customers on how busy they may be at a particular time.

It will be understood that while the present invention has been described primarily with respect to the four party credit card system, it can also be applied, as noted above, to a three party credit card system. Further, with suitable modifications, as will be understood by one skilled in the art, it can be applied to other kinds of payment card systems, such as debit card charging systems.

While most of the discussion above applies to credit card transactions, generally the same networks that are used to process credit card transactions also can be used to process debit cards and prepaid or preloaded payment cards. Point of sale devices such as those of FIG. 1, as well as gasoline pumps, and other places where a product may be sold, are equipped with input devices, such as push buttons or touch sensitive regions, which are used to indicate whether a payment card is a credit card or a debit card, or in some cases, some other type of payment card. While the legal rules for these different types of payments vary, they are processed in very similar ways at the point of sale.

One significant way in which debit cards depart from credit cards is the processing required to settle a transaction. While transaction concentrators can be used, the acquiring bank receives payment directly from the account of a cardholder, usually at another bank. Generally all of the funds required for the transaction must be on deposit in the account tied to the debit card, before the transaction will be approved. However, some banks have permitted transactions to be conducted involving more funds than are on deposit.

Settlement is similar for prepaid or preloaded cards. An account is established at a financial institution containing a predetermined amount of funds. When the card is presented for payment, funds are withdrawn from the account in an amount sufficient to cover the transaction. Purchases wherein an attempt is made to use more money than is in the account will not be approved.

In all of these cases, the record of transaction contains virtually the same information as discussed above. Thus, the operation of the disclosed embodiment may be essentially identical to what is disclosed with respect to FIG. 2.

It will be understood that the invention may be embodied in a computer readable non-transitory storage medium storing instructions of a computer program which when executed by a computer system results in performance of steps of the method described herein. Such storage media may include any of those mentioned in the description above.

The techniques described herein are exemplary, and should not be construed as implying any particular limitation on the present disclosure. It should be understood that various alternatives, combinations and modifications could be devised by those skilled in the art. For example, steps associated with the processes described herein can be performed in any order, unless otherwise specified or dictated by the steps themselves. The present disclosure is intended to embrace all such alternatives, modifications and variances that fall within the scope of the appended claims.

The terms “comprises” or “comprising” are to be interpreted as specifying the presence of the stated features, integers, steps or components, but not precluding the presence of one or more other features, integers, steps or components or groups thereof.

What is claimed is:

1. A system for determining at least one of vehicle and pedestrian congestion at locations, comprising:
an electronic storage device having a database of merchant transactions stored therein;
an access path for allowing access to information concerning the transactions, including when point of sale transactions have taken place, and
a processor for assembling the information concerning point of sale transactions, to provide an indication of at least one of vehicle and pedestrian congestion.

2. The system of claim 1, wherein the database has data concerning transactions in a given geographic region.

3. The system of claim 1, wherein the database has data relating to payment card transactions, and the data is filtered to remove card holder information related to the transactions.

4. The system of claim 1, wherein the access path comprises a web site for making the data available to users of said web site.

5. The system of claim 4, wherein the access path includes an Internet connected device for connecting to said web site.

6. The system of claim 5, wherein said Internet connected device is one selected from the group consisting of a mobile telephone, a computer, a tablet, and a personal digital assistant.

7. The system of claim 5, wherein said Internet connected device includes at least one of a GPS receiver and a location input screen for specifying location of said Internet connected device.

8. The system of claim 5, wherein said Internet connected device includes a display screen for displaying information concerning merchant establishments at a place where congestion is present.

9. The system of claim 8, wherein said merchant establishments are displayed as markers on a map.

10. The system of claim 9, wherein when data in said database indicates that there is no longer congestion at a location, a marker corresponding to the merchant establishment is changed.

11. The system of claim 1, configured to process at least one of a credit card, a debit card, and a prepaid payment card transaction.

12. A method for determining at least one of vehicle and pedestrian congestion at locations, comprising:
storing in an electronic storage device a database of merchant transactions;
accessing information in the database concerning the transactions, and
assembling the information to provide an indication of at least one of vehicle and pedestrian congestion.

13. The method of claim 12, wherein the database has data concerning transactions in a given geographic region.

14. The method of claim 12, wherein the data in the database concerns payment card transactions, and the method further comprises, filtering the data to remove card holder information related to the transactions.

15. The method of claim 12, wherein said accessing comprises using a web site for making the data available to users of said web site.

16. The method of claim 12, wherein said accessing comprises using an Internet connected device for connecting to said web site.

17. The method of claim 16, wherein said Internet connected device that is used is one selected from the group consisting of a mobile telephone, a computer, a tablet, and a personal digital assistant.

18. The method of claim 16, further comprising using, in said Internet connected device, at least one of a GPS receiver and a location input screen, for providing location of said Internet connected device.

19. The method of claim 16, further comprising displaying information concerning merchant establishments in regions of congestion, on a display screen of said Internet connected device.

20. The method of claim 19, wherein said information is displayed on said display screen as a real time map indicating location of merchant establishments.

21. The method of claim 20, wherein said merchant establishments in regions that are congested are displayed as markers on said map.

22. The method of claim 21, wherein when data in said database indicates that congestion is no longer present in a region where a merchant is located, the marker is changed as a warning.

23. The method of claim 12, wherein the payment card transactions are performed by using credit cards, debit cards, and prepaid cards.

24. A computer readable non-transitory storage medium storing instructions of a computer program which when executed by a computer system results in performance of steps of a method for determining regions of at least one of vehicle and pedestrian congestion, comprising:
storing in an electronic storage device a database of merchant transactions;
accessing information in the database concerning the transactions, and
assembling the information to provide an indication of at least one of vehicle and pedestrian congestion at a given region.
